(19) United States
(12) Patent Application Publication
(10) Pub. No.: US 2025/0180364 A1
(43) Pub. Date: Jun. 5, 2025

(54) AUGMENTING VEHICLE ROUTING INFORMATION

(71) Applicant: Rivian IP Holdings, LLC, Irvine, CA (US)

(72) Inventors: Evelyn Anne FISHER, Bozeman, MT (US); Colin William CRENSHAW, Portola Valley, CA (US)

(21) Appl. No.: 18/965,978

(22) Filed: Dec. 2, 2024

Related U.S. Application Data
(60) Provisional application No. 63/606,063, filed on Dec. 4, 2023.

(51) Int. Cl. G01C 21/34

(52) U.S. Cl. CPC G01C 21/3415; G01C 21/3469; G01C 21/3492

(57) ABSTRACT

A vehicle includes an output device configured to communicate information to a driver of the vehicle. The vehicle further includes a control system configured to: receive first map data from a first source, the first map data including one or more first routes; supplement the first map data with supplemental mapping information; and display, via the output device, navigation directions according to: (i) the first map data and (ii) the supplemental mapping information. The supplemental data may be second map data from a second source, which may include one or more second routes. If the second routes are found to match the first routes, information, such as ETAs of the one or more second routes, may be used for the supplemental mapping information or to select among multiple first routes.

### RELATED APPLICATION

This application claims the benefit of U.S. Application Ser. No. 63/606,063 filed Dec. 4, 2023 and entitled AUGMENTING VEHICLE ROUTING INFORMATION.

### INTRODUCTION

The present disclosure relates to augmenting vehicle routing information.

### SUMMARY

In one aspect, a vehicle includes an output device configured to communicate information to a driver of the vehicle. The vehicle further includes a control system configured to: receive first map data from a first source, the first map data including one or more first routes; supplement the first map data with supplemental mapping information; and display, via the output device, navigation directions according to: (i) the first map data and (ii) the supplemental mapping information.

### BRIEF DESCRIPTION OF THE DRAWINGS

FIG. 1A illustrates an example vehicle that may be operated in accordance with certain embodiments.

FIG. 1B illustrates a chassis of a vehicle that may be operated in accordance with certain embodiments.

FIG. 2 is a schematic block diagram of components for operating a vehicle in accordance with certain embodiments.

FIG. 3A and 3B illustrates routing information from multiple sources that may be used to display augmented routing information.

FIG. 4 illustrates a method for displaying augmented routing data in accordance with certain embodiments.

### DETAILED DESCRIPTION

Modern vehicles typically include a screen on which an on-board computer of the vehicle displays routing information. The routing information may include a map as well as turn-by-turn directions directing a driver how to arrive at a particular destination that is inputted to the vehicle. There are various sources of map data as well as other sources of information that are helpful in determining a route for a vehicle, such as traffic data, traffic event locations and types, road construction data, road surface attributes (e.g., data for determining rolling resistance), or other information. Although an individual source of map data may provide useful routing information, it can be the case that no single source will provide all available data that may be useful for routing and navigation in the vehicle.

According to the approach described herein, multiple sources of data are used to augment map and routing data, such as different vendors providing different application programming interfaces (API), mapping software executing on the vehicle itself, vehicle data, government-provided information, and the like. Route data from one or more sources can then be compared and/or modified based on another set of data—additional route data from another provider, vehicle data such as drive more, driver, or range calculations, and the like.

In an example use case, map data related to a driver's specified start and end locations is obtained from multiple sources and can be evaluated to determine whether routes described in the map data substantially match. If so, routing information from one source may be displayed and used to provide turn-by-turn directions with additional helpful information being displayed from one or more other sources.

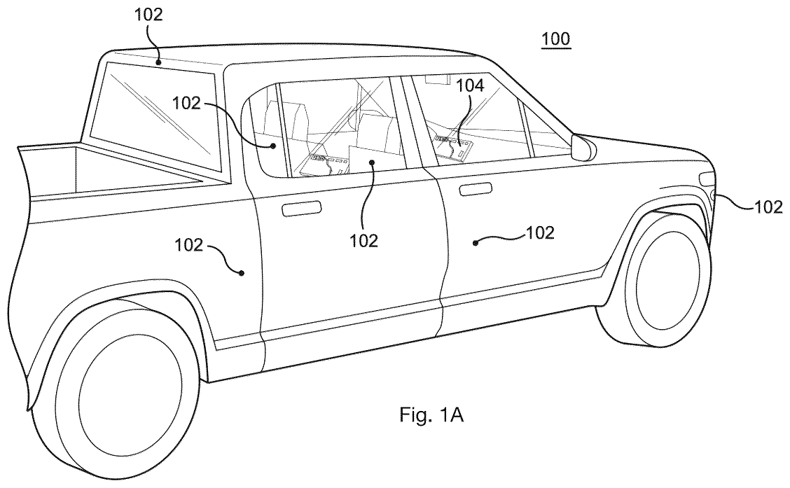

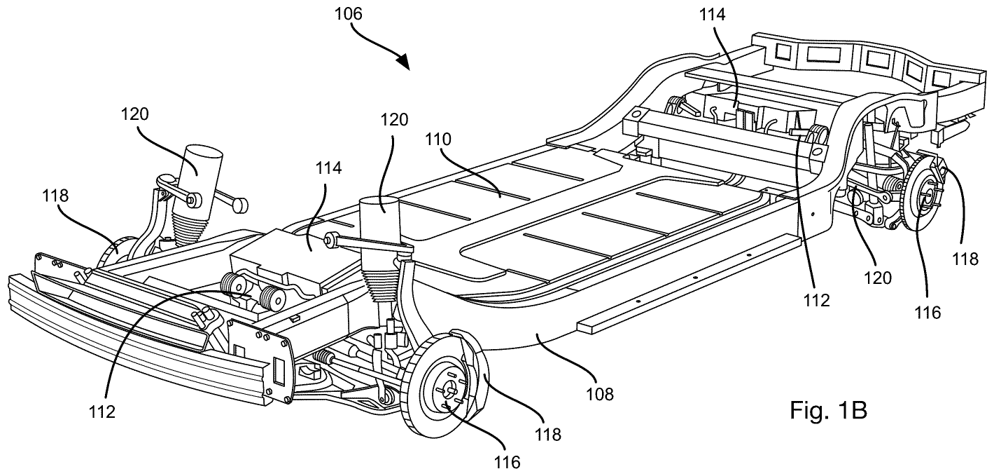

FIG. 1A illustrates an example vehicle 100. As shown in FIG. 1A, the vehicle 100 has multiple exterior cameras 102 and one or more front displays 104 that show map and routing information. Each of these exterior cameras 102 may capture a particular view or perspective on the outside of the vehicle 100. The images or videos captured by the exterior cameras 102 may then be presented on one or more displays in the vehicle 100, such as the one or more front displays 104, for viewing by a driver.

Referring to FIG. 1B, the vehicle 100 may include a chassis 106 including a frame 108 providing a primary structural member of the vehicle 100. The frame 108 may be formed of one or more beams or other structural members or may be integrated with the body of the vehicle (e.g., unibody construction).

In embodiments where the vehicle 100 is a battery electric vehicle (BEV) or possibly a hybrid vehicle, a large battery 110 is mounted to the chassis 106 and may occupy a substantial (e.g., at least 80 percent) of an area within the frame 108. For example, the battery 110 may store from 100 to 200 kilowatt hours (kWh). The battery 110 may be a lithium-ion battery or other type of rechargeable battery. The battery may be substantially planar in shape.

Power from the battery 110 may be supplied to one or more drive units 112. Each drive unit 112 may be formed of an electric motor and possibly a gear train providing a gear reduction. In some embodiments, there is a single drive unit 112 driving either the front wheels or the rear wheels of the vehicle 100. In another embodiment, there are two drive units 112, each driving either the front wheels or the rear wheels of the vehicle 100. In yet another embodiment, there are four drive units 112, each drive unit 112 driving one of four wheels of the vehicle 100.

Power from the battery 110 may be supplied to the drive units 112 by power electronics 114 of each drive unit 112. The power electronics 114 may include inverters configured to convert direct current (DC) from the battery 110 into alternating current (AC) supplied to the motors of the drive units 112.

The drive units 112 are coupled to two or more hubs 116 to which wheels may mount. Each hub 116 includes a corresponding brake 118, such as the illustrated disc brakes. The drive units 112 or other component may also provide regenerative braking. Each hub 116 is further coupled to the frame 108 by a suspension 120. The suspension 120 may include metal or pneumatic springs for absorbing impacts. The suspension 120 may be implemented as a pneumatic or hydraulic suspension capable of adjusting a ride height of the chassis 106 relative to a support surface. The suspension 120 may include a damper with the properties of the damper being either fixed or adjustable electronically.

In the embodiment of FIG. 1B and in the discussion below, the vehicle 100 is a battery electric vehicle. However, the systems and methods disclosed herein may be used for any type of vehicle, including vehicles powered by an internal combustion engine (ICE), hybrid drivetrain, hydrogen fuel cell drivetrain, or other type of drivetrain.

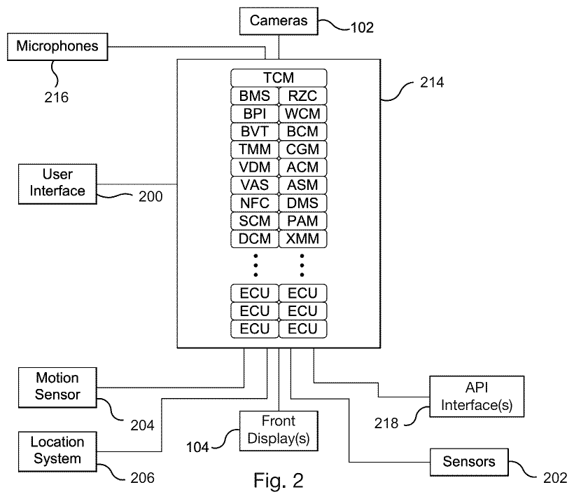

FIG. 2 illustrates example components of the vehicle 100 of FIG. 1A. As seen in FIG. 2, the vehicle 100 includes the cameras 102, the one or more front displays 104, a user interface 200, one or more sensors 202, a motion sensor 204, and a location system 206. The one or more sensors 202 may include ultrasonic sensors, radio detection and ranging (RADAR) sensors, light detection and ranging (LIDAR) sensors, or other types of sensors. The location system 206 may be implemented as a global positioning system (GPS) receiver. The user interface 200 allows a user, such as a driver or passenger in the vehicle 100, to provide input.

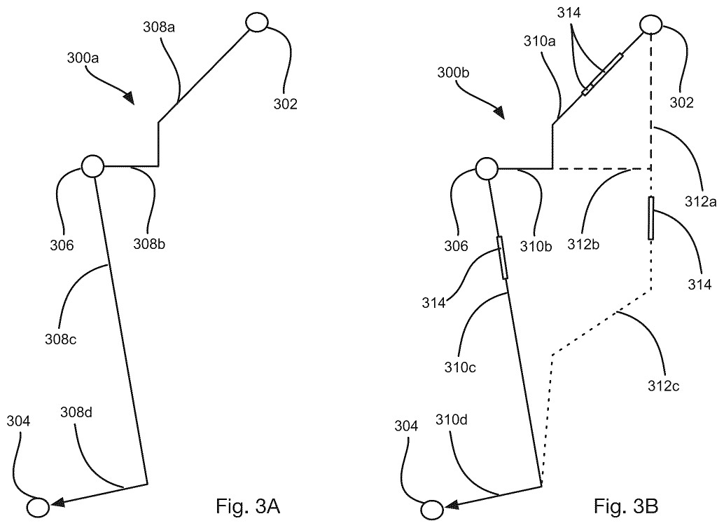

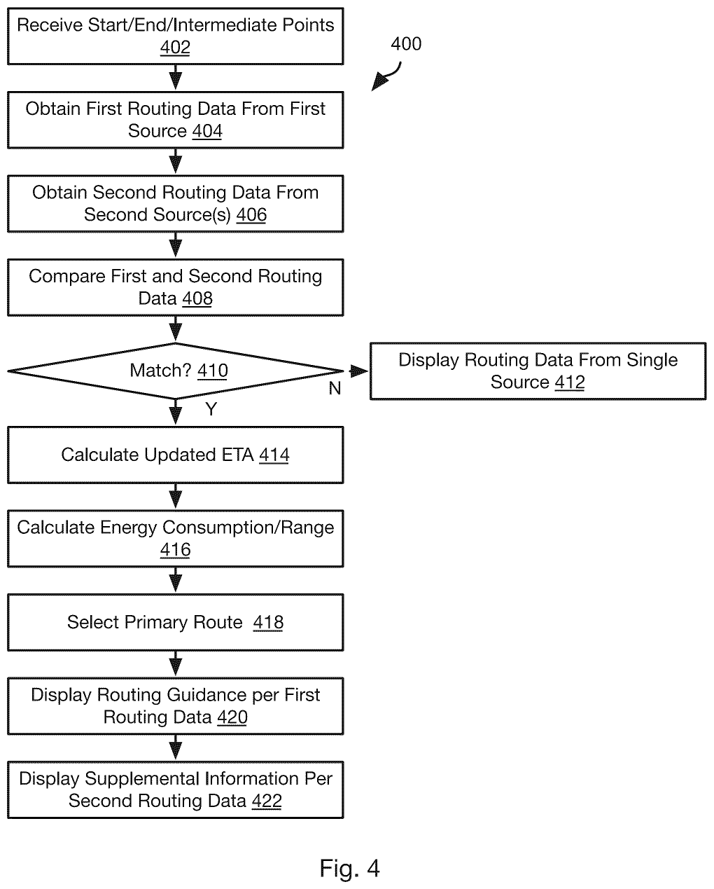

A control system 214 executes instructions to perform at least some of the actions or functions of the vehicle 100, including the functions described in relation to FIGS. 3A, 3B, and 4. For example, as shown in FIG. 2, the control system 214 may include one or more electronic control units (ECUs) configured to perform at least some of the actions or functions of the vehicle 100, including the functions described in relation to FIGS. 3A, 3B, and 4. In certain embodiments, each of the ECUs is dedicated to a specific set of functions. Each ECU may be a computer system and each ECU may include functionality described below in relation to Figs. FIGS. 3A, 3B, and 4.

Certain features of the embodiments described herein may be controlled by a Telematics Control Module (TCM) ECU. The TCM ECU may provide a wireless vehicle communication gateway to support functionality such as, by way of example and not limitation, over-the-air (OTA) software updates, communication between the vehicle and the internet, communication between the vehicle and a computing device, in-vehicle navigation, vehicle-to-vehicle communication, communication between the vehicle and landscape features (e.g., automated toll road sensors, automated toll gates, power dispensers at charging stations), or automated calling functionality.

Certain features of the embodiments described herein may be controlled by a Central Gateway Module (CGM) ECU. The CGM ECU may serve as the vehicle's communications hub that connects and transfer data to and from the various ECUs, sensors, cameras, microphones, motors, displays, and other vehicle components. The CGM ECU may include a network switch that provides connectivity through Controller Area Network (CAN) ports, Local Interconnect Network (LIN) ports, and Ethernet ports. The CGM ECU may also serve as the master control over the different vehicle modes (e.g., road driving mode, parked mode, off-roading mode, tow mode, camping mode), and thereby control certain vehicle components related to placing the vehicle in one of the vehicle modes.

In various embodiments, the CGM ECU collects sensor signals from one or more sensors of vehicle 100. For example, the CGM ECU may collect data from cameras 102, sensors 202, motion sensor 204, and location system 206. The sensor signals collected by the CGM ECU are then communicated to the appropriate ECUs for performing, for example, the operations and functions described in relation to FIGS. 3A to 4.

The control system 214 may also include one or more additional ECUs, such as, by way of example and not limitation: a Vehicle Dynamics Module (VDM) ECU, an Experience Management Module (XMM) ECU, a Vehicle Access System (VAS) ECU, a Near-Field Communication (NFC) ECU, a Body Control Module (BCM) ECU, a Seat Control Module (SCM) ECU, a Door Control Module (DCM) ECU, a Rear Zone Control (RZC) ECU, an Autonomy Control Module (ACM) ECU, an Autonomous Safety Module (ASM) ECU, a Driver Monitoring System (DMS) ECU, and/or a Winch Control Module (WCM) ECU. If vehicle 100 is an electric vehicle, one or more ECUs may provide functionality related to the battery pack of the vehicle, such as a Battery Management System (BMS) ECU, a Battery Power Isolation (BPI) ECU, a Balancing Voltage Temperature (BVT) ECU, and/or a Thermal Management Module (TMM) ECU. In various embodiments, the XMM ECU transmits data to the TCM ECU (e.g., via Ethernet, etc.). Additionally or alternatively, the XMM ECU may transmit other data (e.g., sound data from microphones 216, etc.) to the TCM ECU.

The control system 214 and API interfaces 218 may interface with one or more API interfaces implemented on a remote server, cloud computing platform, or elsewhere. The API interface on the remote server or cloud computing platform may be define function calls for accessing map data from a particular vendor or other source of map data. For example, vendors may include one or more sources of map data that are accessed over a cellular data connection to a server of the vendor using a wireless connection implemented by an on-board cellular data transceiver. Sources of map data accessed using the one or more API interfaces 218 may include map software executing on the vehicle 100 itself. Map data may include routing data, traffic data, and/or range data provided by governments or other sources. Map data may include a heat map showing paths over paved and/or unpaved surfaces traversed by other vehicles and accessed from a remote server or stored locally to the control system 214.

In some embodiments, a source of map data may include a mobile device associated with an owner of a vehicle or authorized by an owner of the vehicle 100 to provide map data. While in the vehicle 100 or remote from the vehicle 100, a user of the mobile device may select map data to be provided to the control system 100, such as using an application configured to interface with the control system 214 directly or by way of an intermediate server. For example, while remote from the vehicle 100, the user of the mobile device may select map data and invoke transmission of the map data to the vehicle 100. Therefore, when the user arrives at the vehicle 100, the map data may already be processed and displayed, such as according to the methods disclosed herein.

FIGS. 3A and 3B illustrate examples of map data obtained from different sources of map data, such as any of the sources of map data described above. Referring to FIG. 3A, a first source of map data may provide one or more routes 300a. The route 300a may be defined as having a starting point 302, ending point 304, and possibly one or more intermediate points 306. The points 302, 304, 306 may represent points provided by the first source with the first source generating one or more routes that intersect the points 302, 304, 306. The one or more intermediate points may represent charging stops, refueling stops, or user-defined waypoints. As is apparent, the route 300a may include one or more legs 308a, 308b, 308c that may represent distances to be traveled along particular roads, such as spans of road between intersections or other landmarks. Each leg may be defined by one or more points, such as one or more points including a latitude and longitude. The points may be defined at arbitrary distances along each leg.

Referring to FIG. 3B, a second source of map data may provide one or more additional routes 300b for the same points 302, 304, 306. The routes 300b may include a route including legs 310a, 310b, 310c, 310d that may correspond identically or approximately the legs 308a, 308b, 308c, 308d of the one or more routes 300a. As used herein, “correspond” may indicate that the legs 310a, 310b, 310c, 310d guide the user to traverse the same roads, but may differ slightly in the coordinates used to define the legs 308a, 308b, 308c, 308d. For example, legs may correspond to one another notwithstanding different points defining turns or different entry points to parking lots, parking structures, or other structures.

The routes 300b may include routes having legs 312a, 312b, 312c that do not correspond to legs of the one or more routes 300a. The routes 300b may include additional information. For example, the routes 300b may include one or more congestion labels 314. Each congestion label 314 may indicate a span of a road represented by the congestion label and a representation of traffic speed along the span. For example, the representation of traffic speed may be a classification of a set of possible classifications, with each classification corresponding to a range of vehicle speeds or a range of percentages describing traffic speed with respect to a speed limit for the span. The congestion labels 314 may be represented on front display 104 or other display device as a color, e.g., red for high congestion, yellow for medium congestion, and green for no congestion.

Each route of the one or more routes 300b may be accompanied by one or more other items of information (herein after “supplemental mapping information”), such as an estimated time of arrival (ETA) for the entire route 300b or an ETA for a portion of the route 300b (e.g., between start point 302 and an intermediate point 306, between the intermediate point 306 and the end point 304, or between a pair of intermediate points 306).

The supplemental mapping information may include data describing one or more legs 310a-310d, 312a-312c of the each route. The data describing a leg may include data describing a speed limit, the availability of a carpool lane, a grade of the road (average or for smaller segments of the leg), a surface roughness, presence of potholes or other obstacles, or any other information that may be relevant to a driver or to determining time and energy consumption when traversing the each leg.

FIGS. 3A and 3B illustrate two sets of one or more routes 300a, 300b. However, in various embodiments, there may be three or more sets of one or more routes. Any of the three or more routes may include any of the types of information described above with respect to the one or more routes 300b.

FIG. 4 illustrates an example method 400 that may be performed by the control system 214 in order to generate routing and other information and to display such information on one or more front displays 104 or other display device of the vehicle 100. The method 400 may also be performed partially or completely on a remote server or cloud computing platform with the routing and other information being transmitted and displayed by the control system 214 on one or more front displays 104. Likewise, inputs used by the method 400 may be received by the control system 214 and transmitted to the remote server for processing. Likewise, inputs used by the method 400 may be stored locally and retrieved and processed with on-board calculations and not rely on any remote server.

The method 400 includes receiving, at step 402, from a user, points such as a start point 302, end point 304, and possibly one or more intermediate points 306. Note that intermediate points 306 may also be automatically generated as part of the method 400. Intermediate points 306 may be generated based on the start and end points 302, 304. For example, an intermediate point 306 may be a location of a charging station or gas station selected based on expected energy consumption traversing a route generated between the start and end points 302, 304, and a current state of charge or amount of fuel of the vehicle 100.

The method 400 may include requesting first routing data from a first source and receiving, at step 404, the first routing data from a first source. The first routing data may include one or more first routes, including the start and end points 302, 304 and possibly one or more intermediate points 306. Step 404 may include receiving any of the above-described other items of supplemental mapping information from the first source. In one example, the first source is a remote server, though the first source may be any of the sources described hereinabove.

The method 400 may include requesting second routing data from a second source and receiving, at step 406, the second routing data from a second source. The second routing data may include one or more second routes including the start and end points 302, 304 and possibly one or more intermediate points 306. Step 406 may include receiving any of the above-described other items of supplemental mapping information from the second source. In one example, the second source is a remote server, though the second source may be any of the sources described hereinabove. Step 406 may be performed with respect to multiple second sources. Accordingly, the “second routing data” referenced herein may include second routing data from multiple second sources.

The method 400 may include comparing, at step 408, the first and second routing data. In particular, each first route in the first routing data may be compared with one or more second routes in the second routing data to determine if at least one route of the second routing data matches the each first route. As noted above, routes may vary from one another while still effectively directing the driver along the same roads. Accordingly, step 408 may be implemented using any approach known in the art for determining whether two routes are sufficiently similar. In one approach, distances between a first route and a second route along the lengths thereof is aggregated to obtain an aggregated distance, and the first and second are determined to match if the aggregated distance is below a threshold. In another approach, the distances between the first route and the second route along the length thereof are calculated and weighted, where distances closer to the start and end points are weighted less. The weighted distances are then aggregated. If the aggregated distances are less than a threshold, the first and second route may be determined to match. Weighting the distances less with proximity to the start and end points accounts for immaterial differences, such as selection of a different entry point to a parking lot or parking structure.

At step 410, control system 214 may evaluate whether at least one of the first routes is found to match at least one of the second routes according to the comparison of step 408. If no match is found, the method may include displaying, at step 412, routing data from only one source, such as the first source, may be used to provide navigation directions (e.g., turn-by-turn directions) to the driver by means of the one or more front displays 104, audible instructions, or other output device.

If at least one of the first routes (“the one or more matching first routes”) is found to match at least one of the second routes (“the one or more matching second routes”) according to the comparison of step 408, first routing data and the second routing data may be further processed.

For example, the method 400 may include calculating, at step 414, an updated ETA. For example, the ETA associated with the each route of the one or more matching second routes may be more accurate than the ETA the corresponding matching first route. Calculating an updated ETA may include replacing the ETA of the matching first route with that of the corresponding matching second route. Calculating an updated ETA may include calculating a scaling factor (e.g., S=ETA2/ETA1), where S is the scaling factor, ETA2 is the ETA of the second matching route and ETA1 is the ETA of the first matching route. The scaling factor may then be used to scale estimated traversal time of individual legs of the first matching route.

In yet another example, where the first matching route lacks congestion labels (see congestion labels 314 in FIG. 3B), step 414 may include mapping differences between ETA2 and ETA1 to portions of the first matching route corresponding to portions of the second matching route that are labeled with congestion labels. For example, the congestion label may indicate a range of speeds or a scaling factor for a portion of the second route. The traversal time for the corresponding portion of the first matching route may therefore be increased in correspondence with the range of speed or scaling factor indicated by the congestion label. In particular, an amount of scaling based on the ratio of ETA1 to ETA2 may be non-uniform along the first matching route with a greater amount of increase associated with portions of the first matching route corresponding to congestion labels and the reductions in speed indicated by the congestion labels. Congestion labels may also be added to renderings of the first matching route by the control system 214 in correspondence with the congestion labels of the second matching route.

Selecting route and calculating the ETA may take into account other factors. For example, where multiple occupants of the vehicle 100 are detected, selecting the route and calculating the ETA may include adjusting route selection and ETA to account for usage of a carpool lane. Multiple occupants may be detected in images from interior camera or using the outputs of weight sensors in seats for enabling and disabling air bags and/or for determining whether a passenger has not fastened their seat belt. Appropriateness of calculating ETA for the carpool lane may also be based on a record indicating purchase of a pass or permission for the vehicle to use the carpool lane as an electric vehicle or for some other reason.

Selecting route and calculating the ETA may be performed using a machine learning model that takes into account any of the factors referenced above. For example, a machine learning model may relate driver behavior to ETA, for example, by estimating how a driver may drive more aggressively in some scenarios, resulting in an earlier ETA.

The method 400 may include calculating, at step 416, energy consumption and/or range of the vehicle 100. For example, the supplemental mapping information from the second source may indicate the one or more properties of road surfaces traversed according to the one or more second matching routes, such as elevation gain/loss, surface roughness, grade, potholes, other obstructions, or other properties. Accordingly, expected energy consumption while traversing the one or more first matching routes may be adjusted based on the one or more properties in the supplemental mapping information. The change in range of the vehicle resulting from traversing the one or more first matching routes may then be updated according to the expected energy consumption. Likewise, the location and expected duration of necessary charging stops may be determined according to the expected energy consumption and current state of charge of the vehicle 100. The duration of charging stops may be used to update ETAs calculated as described above.

Some or all of route selection, ETA, and the expected energy consumption may take into account other factors, such as vehicle dynamics of the vehicle 100, such as vehicle dynamics defined for a given drive mode of the vehicle. For example, the currently selected drive mode, whether the vehicle is towing a trailer, whether the vehicle is off-roading, or other attributes or settings of the vehicle 100 may be used as an input to determine expected energy consumption, selection of a primary route, and/or calculation of ETA. The expected energy consumption may be computed at least partially using a machine learning model trained to predict user behavior, such as behavior related to energy consumption. For example, a machine learning model may relate driver behavior to ETA, for example, by estimating how a driver may drive more aggressively and use energy less efficiently in some scenarios.

The method 400 may include selecting, at step 418, a primary route, where the one or more first routes include a plurality of first routes. Step 418 may include using the one or more second routes to select from among the plurality of first routes. Factors such as ETA and energy consumption described above may be considered at step 418: the second route with the lowest ETA, lowest energy consumption, or a weighted combination thereof, may be selected, and the first route matching the selected second route may then be selected as the primary route.

The method 400 may include displaying, at step 420, routing guidance according the first routing data. The routing guidance may include displaying a map with the first routing data imposed thereon. Turn-by-turn directions may be displayed using the first routing data and a currently detected location of the vehicle 100. The routing guidance may be for one of the first routes, such as the primary route selected at step 418 or a different route selected by the user from among the one or more first routes.

The method 400 may include displaying, at step 422, supplemental mapping information included in, or derived from, the second routing data. The supplemental mapping information may include an ETA calculated at step 414, a range calculated at step 416, or other information. In another example, the supplemental mapping information may include a recommended speed, e.g., a speed selected to improve range of the vehicle 100 based on the speed limit and/or the one or more properties of the road surface being traversed by the vehicle 100 and possibly based on the state of charge of the battery 110, for example, as described above with respect to FIG. 1.

In some embodiments, one or both of the first map data and the second map data may be refreshed. In particular, traffic data may change over time such that updated ETA or congestion labels may be received by the control system 214. The method 400 may therefore be partially or completely repeated each time the first or second map data is refreshed. For example, processing may be repeated from step 414 with the calculating of an updated ETA based on the refreshed first or second map data.

The descriptions of the various embodiments of the present disclosure have been presented for purposes of illustration. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure may exceed the specific described embodiments. Instead, any combination of the features and elements, whether related to different embodiments, is contemplated to implement and practice contemplated embodiments. Furthermore, although embodiments disclosed herein may achieve advantages over other possible solutions or over the prior art, the embodiments may achieve some advantages or no particular advantage. Thus, the aspects, features, embodiments and advantages discussed herein are merely illustrative.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a one or more computer processing devices. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Certain types of storage devices that include these mediums include: diskette, hard disk, random access memory (RAM), read only memory (ROM), erasable programmable read only memory (EPROM or Flash memory), static random access memory (SRAM), compact disc read only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, refers to non-transitory storage rather than transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but the storage device remains non-transitory during these processes because the data remains non-transitory while stored.

While the foregoing is directed to embodiments of the present disclosure, other and further embodiments may be devised without departing from the basic scope thereof, and the scope thereof is determined by the claims that follow.

What is claimed is:

1. A vehicle, comprising:
an output device configured to communicate information to a driver of the vehicle; and
a control system configured to:
receive first map data from a first source, the first map data including one or more first routes;
supplement the first map data with supplemental mapping information; and
display, via the output device, navigation directions according: (i) to the first map data and (ii) the supplemental mapping information.

2. The vehicle of claim 1, wherein the first source comprises a remote server.

3. The vehicle of claim 1, wherein the control system is further configured to obtain the supplemental mapping information from second map data received from a second source.

4. The vehicle of claim 3, wherein the second source comprises a remote server.

5. The vehicle of claim 3, wherein the second source is local to the vehicle.

6. The vehicle of claim 3, wherein the second map data includes one or more second routes.

7. The vehicle of claim 6, wherein the control system is further configured to:
determine (a) that at least one of the one or more first routes matches at least one of the one or more second routes; and
in response to (a), determine the supplemental mapping information from the second map data.

8. The vehicle of claim 7, wherein the second map data includes a second estimated time of arrival, and the supplemental mapping information includes an updated estimated time of arrival based on the second estimated time of arrival.

9. The vehicle of claim 8, wherein the first map data includes a first estimated time of arrival, and the updated estimated time of arrival is based on the first estimated time of arrival and the second estimated time of arrival.

10. The vehicle of claim 7, wherein the second map data includes one or more congestion labels for the one or more second routes, the supplemental mapping information being based on the one or more congestion labels.

11. The vehicle of claim 7, wherein the second map data includes one or more road surface properties for the one or more second routes, and the control system is further configured to calculate energy usage information for the at least one of the one or more first routes based on the one or more road surface properties, the supplemental mapping information including the energy usage information.

12. The vehicle of claim 11, wherein the energy usage information includes a driving range of the vehicle.

13. The vehicle of claim 11, wherein the one or more road surface properties include a surface roughness.

14. The vehicle of claim 6, wherein the one or more first routes include a plurality of first routes, and the one or more second routes include a plurality of second routes, the plurality of second routes each having a second estimated time of arrival associated therewith, the control system being configured to:
determine (a) that the plurality of first routes matches the plurality of second routes; and
in response to (a), select a primary first route from the plurality of first routes according to the second estimated times of arrival of the plurality of second routes.

15. A method comprising:
receiving, by a control system of a vehicle, at start point and an end point;
receiving, from a first source and by the control system of the vehicle, first map data including one or more first routes between the start point and the end point;
receiving, from a second source and by the control system of the vehicle, second map data; and
displaying navigation directions according to: (i) the one or more first routes and (ii) supplemental mapping information derived from the second map data.

16. The method of claim 15, wherein the first source comprises a first remote server, and the second source comprises at least one of a source local to the vehicle and a second remote server.

17. The method of claim 15, wherein the second map data includes one or more second routes, and the method further comprises:
determining, by the control system, (a) that at least one of the one or more first routes matches at least one of the one or more second routes; and
deriving, by the control system, the supplemental mapping information from the second map data in response to (a).

18. The method of claim 17, calculating, by the control system, the supplemental mapping information as an updated estimated time of arrival based on: (i) a first estimated time of arrival included in the first map data and (ii) a second estimated time of arrival that is based on the first map data.

19. The method of claim 17, wherein the second map data includes one or more congestion labels for the one or more second routes, the supplemental mapping information being based on the one or more congestion labels.

20. The method of claim 17, wherein the second map data includes one or more road surface properties for the one or more second routes, the method further comprising calculating energy usage information for the at least one of the one or more first routes based on the one or more road surface properties, the supplemental mapping information including the energy usage information.
